(19) United States
(12) Patent Application Publication
(10) Pub. No.: US 2010/0017245 A1
(43) Pub. Date: Jan. 21, 2010

(54) RESERVATION MANAGEMENT

(75) Inventors: MORTEN KRISTIANSEN, Ratoath (IE); Bryan D. Osenbach, Cary, NC (US); Jeffrey B. Sloyer, Fishersville, VA (US); Hema Srikanth, Raleigh, NC (US)

Correspondence Address: FLEIT GIBBONS GUTMAN BONGINI & BIANCO P.L., ONE BOCA COMMERCE CENTER, 551 NW 77TH STREET, SUITE 111, BOCA RATON, FL, 33487, US

(73) Assignee: International Business Machines Corp., Armonk, NY (US)

(21) Appl. No.: 12/174,343

(22) Filed: Jul. 16, 2008

(51) Int. Cl. G06Q 10/00

(52) U.S. Cl. 705/8

(57) ABSTRACT

A method, information processing system, and computer program product managing reservations of items. A request to reserve an item is received from a first user. The request includes a specification of at least one of a date and a time for a first reservation of the item. A determination is made that a second user holds a prior reservation for the item that conflicts with the first reservation. A determination is made that the second user is no longer requires the prior reservation. The prior reservation is released in response to determining that the second user no longer requires the prior reservation. The first reservation as specified by the request is allowed in response to the releasing and in response to the receiving from the first user the request.

### FIELD OF THE INVENTION

The present invention generally relates to the field of reservation systems, and more particularly relates to dynamically managing reservation conflicts.

### BACKGROUND OF THE INVENTION

Reservation systems allow individuals to reserve conference rooms, hotel rooms, airline flights, and various other items. For example, a business can implement a reservation system that allows its employees to reserve a conference room for a particular date and time. One problem with current reservation systems is that they generally do not dynamically manage the reservations to determine whether or not a person holding the current reservation still requires that reservation. Using the above example, a current user that has a conference room reservation may no longer need the reservation. If the user does not manually notify the reservation system that the current reservation is no longer needed, that particular conference room is unnecessarily kept out of the pool of available rooms. The same problem exists for other types of reservation systems such as those directed to hotel room reservations.

Therefore a need exists to overcome the problems with the prior art as discussed above.

### SUMMARY OF THE INVENTION

In one embodiment, a method for managing reservations of items is disclosed. The method includes receiving a request to reserve an item from a first user. The request includes a specification of at least one of a date and a time for a first reservation of the item. A determination is made that a second user holds a prior reservation for the item that conflicts with the first reservation. A determination is made that the second user is no longer requires the prior reservation. The prior reservation is released in response to determining that the second user no longer requires the prior reservation. The first reservation as specified by the request is allowed in response to the releasing and in response to the receiving from the first user the request.

In another embodiment, an information processing system for managing reservations of items is disclosed. The information processing system includes a memory and a processor communicatively coupled to the memory. A reservation manager is communicatively coupled to the memory and the processor. The reservation manager includes a reservation request manager that is adapted to receive from a first user a request to reserve an item. The request comprises a specification of at least one of a date and a time for a first reservation of the item. A reservation conflict manager is adapted to determine that a second user holds a prior reservation for the item that conflicts with the first reservation. The reservation conflict manager is further adapted to determine that the second user no longer requires the prior reservation. A reservation availability manager is adapted to release, in response to reservation conflict manager determining that the second user no longer requires the prior reservation, the prior reservation. A reservation scheduling manager is adapted to allow, in response to the reservation availability manager releasing and in response to the reservation request manager receiving from the first user the request, the first reservation as specified by the request.

An advantage of the various embodiments of the present invention is that reservations are dynamically and autonomically monitored to ensure that items are not being unnecessarily reserved. For example, various embodiments of the preset invention can query a current reservation holder to determine if that reservation is still required. Also, the various embodiments can monitor organizational changes to determine if an employee changes positions or divisions, leaves the company, or the like, to automatically update reservations held by these employees.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a general overview of an operating environment according to one embodiment of the present invention;

FIG. 2 is an operational flow diagram illustrating one example of dynamically and autonomically managing reservations according to one embodiment of the present invention; and

FIG. 3 is a block diagram illustrating a detailed view of an information processing system, according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

General Operating Environment

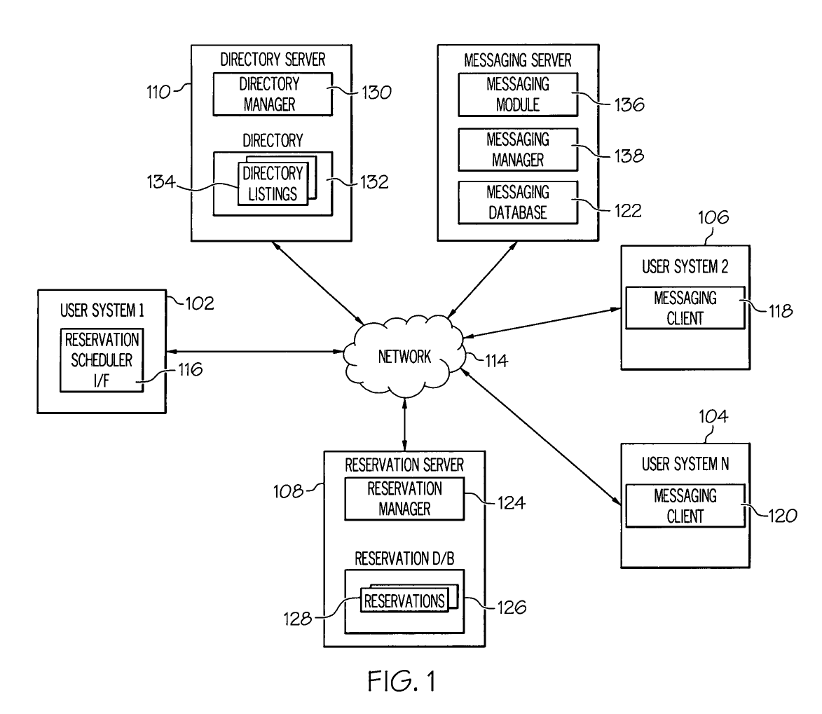

According to one embodiment of the present invention as shown in FIG. 1 a general overview of an operating environment 100 is illustrated. In particular, FIG. 1 shows an operating environment 100 for dynamically and autonomically managing reservations. It should be noted that although the following discussion uses conference rooms as one example of an item being reserved, the present invention is not limited to such an example. For example, the various embodiments of the present invention are also applicable to (but not limited to) hotel room reservation systems as well.

The operating environment 100, in one embodiment, includes a plurality of user systems 102, 104, 106 that are communicatively coupled to one or more information processing systems 108, 110, 112 via one or more networks 114. The network(s) 114, in one embodiment, are wired and/or wireless networks. The user systems 102, 104, 106 can be (but not limited to) a desktop computer, a notebook, a workstation, a personal digital assistant, a telephone unit, or a wireless communication device such as (but not limited to) a cell phone and a smart phone. In one embodiment, the information processing systems are a reservation server 108, a directory server 100, and a messaging server 112.

Each of the user systems 102, 104, 106 can include a reservation scheduler interface 116 and/or a messaging client 118, 120. Each of the reservation scheduler interface 116 and messaging client 118, 120 is discussed in greater detail below. The reservation server 108, in one embodiment includes a reservation manager 124, and a reservation database 126 including reservation information 128. The directory server 110, in one embodiment, includes a directory manager 130 and a directory 132, which includes directory listings 134. The messaging server 112, in one embodiment, includes a messaging module 136 and a messaging manager 138. Each of the reservation server 108, directory server 110, messaging server 112, and their respective components are discussed in greater detail below.

It should be noted that in an embodiment directed towards, for example, hotel room reservations, the directory server 110 is not required. It should also be noted that although the reservation server 108, directory server 110, and the messaging server 112 are shown as separate entities, they can all reside at a single system. Also, the components of each of the servers shown in FIG. 1 are not required to be separate modules. For example, one of more of these components can be combined or implemented within a single module.

Dynamic and Autonomic Reservation Management

As discussed above, the following discussion uses reservations directed to conference rooms as only one example of an embodiment of the present invention. Many businesses and corporations utilize a conference room reservation system that allows its employees to reserve conference rooms and/or resources for conference rooms. However, in many instances a reserved conference room or resource may no longer be needed. For example, a meeting or event that was to take place within that conference room may have been cancelled. Alternatively, the employee who scheduled the conference room may no longer work for the business or has changed job roles and/or divisions within the company, thereby making the reservation no longer needed. In many instances an employee places on going reservations that occur daily, weekly, or monthly. If the employee changes divisions, jobs, or leaves the company, this reoccurring reservation might no longer be needed.

Also, in addition to the actual conference room being reserved, employees can reserve resources such as (but not limited to) audio/visual equipment and computing equipment that are to be used during the meeting/event associated with the reserved conference room. Therefore, if a conference room is no longer required any resources that have been reserved for that conference room are also no longer required.

Conventional reservation systems generally do not comprise autonomic updating capabilities. For example, if a conference room is no longer required, conventional systems do not place the conference back into the pool of available rooms unless the employee who has reserved the room manually notifies the reservation system that the conference room is no longer needed. This is problematic because in many instances conference rooms are scheduled months in advance for reoccurring days. If an employee does not notify the reservation system that the rooms are no longer needed, a large number of rooms or available days are unnecessarily made unavailable.

In one embodiment, a user interacts with the reservation server 108 to reserve a conference room and any needed resources for a particular date(s). These reservations can be set as one time reservations or reoccurring reservations. For example, the user can create a reservation that is setup every Monday for the remainder of the year. The user interacts with the reservation server 108, in one embodiment, via a reservation scheduler interface 116. The reservation scheduler interface 116 can be part of a web application, a stand alone application, or integrated into another application.

The reservation scheduler interface 116 at the user system 102 interacts with the reservation manager 124 at the reservation server 108. The reservation manager 124 receives the reservation request from the user via the reservation scheduler I/F 116 and determines if the requested reservation is possible.

For example, if User A requests to reserve Conference Room Z on Monday at 3:00 p.m., the reservation manager 124 analyzes the reservation database 126 and the current reservations 128 to determine if Conference Room Z is available on Monday at 3:00 p.m. If this determination is positive, the reservation manager 124 updates the reservation listings 128 in the reservation database 126 to reflect that User A has reserved Conference Room Z. However, if the reservation manager 124 determines that the request conference room is not available at the time and date request by the user, the reservation manager 124 can perform various operations.

In one embodiment, the reservation manager 124 identifies the conflicting reservation in the reservation database 126. For example, the reservation manager 124 identifies the current preexisting reservation for Conference Room Z on Monday at 3:00 p.m. The reservation manager 124 analyzes this pre-existing reservation and identifies one or more users (e.g. User B) who have scheduled this reservation. The reservation manager 124, in this embodiment, then communicates with the messaging server 112 so that the user(s) who scheduled the pre-existing reservation can be queried. For example, the reservation manager 124 notifies the messaging manager 138 that User B needs to be queried to determine whether User B still wants to keep his/her reservation.

The messaging manager 138 then determines one or more messaging mechanisms to use for contacting User B. The messaging mechanisms associated with users can be maintained in a messaging database 122 or in a directory database 132 (if available) within a directory listing 134 for the user. A user can be associated with multiple different messaging mechanisms such as (but not limited to) email, pager, text messages, multimedia messages, instant messages, and landline/cellular. In one embodiment, the messaging client 118, 120 of a user system allows a user to communicate via one or more of these messaging mechanisms.

The messaging manager 138, via the messaging module 136, sends an automated message to the user, User B in this example, requesting that User B confirms his/her current reservation for Conference Room Z. User B receives this message via the messaging client 118, 120. User B is able to respond to the received message via the messaging client 118, 120, which sends the message back to the messaging server 112. The messaging manager 138 receives the response sent from the user and notifies the reservation manager 124 of the response. If User B confirms the reservation, the reservation manger maintains the current reservation for Conference Room Z.

The requesting user, User A in this example, is notified that the Conference Room Z has already been reserved for the requested time and date. However, if the response from User B indicates that User B no longer requires the reservation, the reservation manager 124 releases the current reservation for Conference Room Z made by User B and replaces the reservation with the reservation requested by User A. Alternatively, if User B does not respond to the message sent by the messaging manager 138 within a given amount of time, the reservation manager 124 of one embodiment is able to automatically release the reservation held by User B and enter the reservation request of User A.

In another embodiment, a user is not required to specify a particular day, time, and/or conference room to be reserved. For example, a user, via the reservation scheduler I/F 116 can query the reservation server 108 for all available conference rooms on a particular date(s) and/or a particular time. Also, a user can query the reservation server 108 with respect to a particular conference room. For example, a user can request a list of available dates and/or times for a particular conference room. When the reservation manager 124 receives these types of requests, it identifies dates, times, and conference rooms that are not associated with a reservation. These are flagged with a status of available. For dates, times, and conference rooms that are reserved, the reservation manager 124 instructs the messaging manger 138 to operate in a similar mode to that discussed above. The messaging manager 138 sends out a message to the each user who created the reservation associated with a particular time, date, and conference room corresponding to the user request. The reservation manager 124 is notified of the user responses or lack of responses and updates the reservation database accordingly. The requesting user is then presented with an availability list indicating available conference rooms.

In another embodiment, the reservation manger 124 is not required to wait until a specific reservation request is received to query current reservation holders. For example, the reservation manager 124, in this embodiment, automatically instructs the messaging manager 138 to query reservation holders at various given intervals of time. Also, the reservation manager 124 can monitor a calendar application of each employee or a company calendar. In this embodiment, the calendar includes reservation information and when an employee makes a change to the reservation information within a calendar or information associated with a reservation (e.g. changes a time for a meeting to be held in the reserved conference room) the reservation manager 124 updates the reservation database 126 accordingly. Therefore, the reservation database can maintain a reservation database that is as up-to-date as possible.

In a further embodiment, the reservation manager 124 monitors directory information 134 of a business/corporation. In this embodiment, the directory 132 can be a directory/management chain supporting organizational the Lightweight Directory Access Protocol (“LDAP”) or any other directory implementation. The directory 132 maintains directory listings 134 including information associated with each employee of the business/corporation.

This information can include (but is not limited to) hierarchical relationships information (e.g., relationships between individuals such as worker-manager; worker-co-worker; and the like); an employee's job description; division information; messaging capabilities and addresses; personal information such as address, phone number; and status (e.g., manager). The directory manager 130 maintains and updates the directory 132 according to various events. For example, an employee may get promoted, switch divisions, leave the company, change phone numbers or messaging capabilities, and the like. The directory manager 130 can receive information from a system administrator or a computer system regarding these events and update the directory 132 accordingly.

When the reservation manager 124 receives a reservation request from a user, the reservation manager 124 analyzes the reservation database 126, as discussed above. If the reservation request can be satisfied, the reservation manager 124 schedules the requested reservation. However, if a reservation has already been made by another employee that satisfies the requesting user's criteria, the reservation manager 124 analyzes the directory 132 (either directly or through the directory manager 130) for information associated with the user who has made the reservation. The messaging manager 128 then contacts the user who has made the reservation as discussed above. If the user does not respond within a given amount of time or indicates that the reservation is no longer required, the requesting user is assigned to the reservation.

In another embodiment, the reservation manager 124 monitors collaborative environments that allow users to collaborate on projects over a network and setup various activities and meetings. One example of a collaborative environment is Lotus Connections from International Business Machines, Inc. In this embodiment, the reservation manager 124 monitors scheduled activities involving one or more employees. The activity can be a meeting that has been scheduled for a particular date and time and where a particular conference room and/or resources have been reserved for this activity.

The reservation manager 124 of one embodiment monitors activity within collaborative environments for any changes and updates the reservation associated with the activity accordingly. The reservation manager 124 can integrate with the collaborative environment to communicate with each employee associated with the activity to determine if a current reservation is still required. For example, the reservation manager 124 can send out an automated messaged requesting confirmation of the continued need for reserved rooms and/or resources. The employees can be given a certain amount of time to respond. If the employees do not respond, the reserved room and/or resources are made available to other employees. Also, the reservation manager 124 can be configured to send out reminder notices to employees associated with a reserved room. If one or more of the employees do not respond to the notice, the reserved room/resources can be made available to other employees.

It should be noted that with any of the embodiments discussed above, a user requesting a reservation can communicate a message his/herself to a current reservation holder. The reservation manager 124 can monitor these messages and update the reservation database based on the response given by the current reservation holder. Also, some users such as managers and administrators can be given the ability to override a current reservation and delete or reassign a current reservation. In one embodiment, if the reservation manager 124 has not received a response back from a current reservation holder, the reservation manager 124 can query the employee's manager to get a response. This information can be obtained from the directory 132 discussed above.

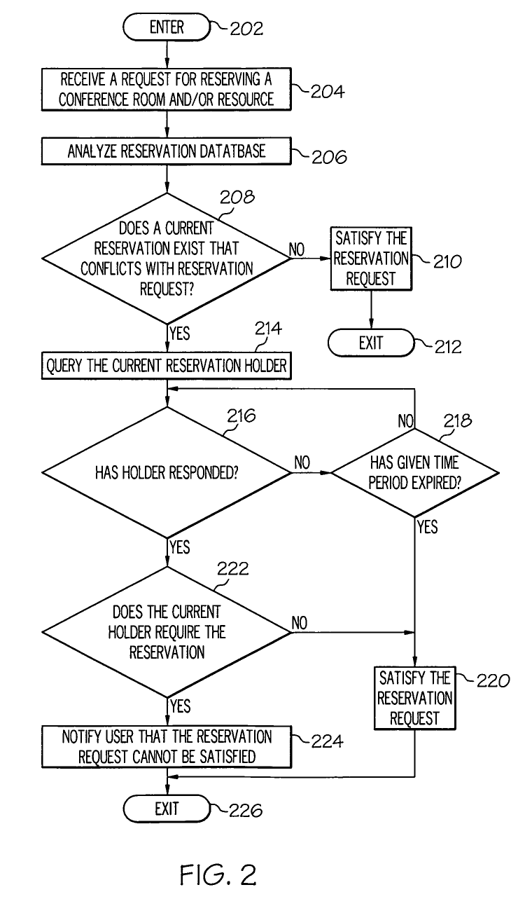

FIG. 2 is an operational flow diagram illustrating a process of dynamically and autonomically managing conference reservations. The operational flow diagram of FIG. 2 begins at step 202 and flows directly to step 204. The reservation manager 124, at step 204, receives a request for reserving a conference room and/or resource. The reservation manager 124, at step 206, analyzes the reservation database 126 to determine if the reservation request can be satisfied. The reservation manager 124, at step 208, determines if a current reservation already exist that conflicts with the reservation request.

If the result of this determination is negative, the reservation manager 124, at step 210, satisfies the reservation request by reserving the conference room and/or resources according to the request. The control flow then exists at step 212. If the result of this determination is positive, the reservation manager 124, at step 214, queries the reservation holder. In another embodiment, the reservation manager 124 can query the organizational directory 132 to determine if the current reservation holder is still associated with the same job, division, or the like as when the reservation was made. The reservation manager 124 can then update the reservation database 126 accordingly, as discussed above.

Returning to step 214, the reservation manager 124 can query the current reservation holder via the messaging manager 138 to determine if the holder still requires the reservation. The reservation manager 124, at step 216, determines if the holder has responded. If the holder has not responded, the reservation manager 124, at step 218, determines if a given time period has expired. If so, the requesting user's reservation request is satisfied. The control flow then exits at step 226. If the time period has not expired, the reservation manager 124 continues to monitor for a response at step 216. If the user has responded, the reservation manager 124, at step 222, determines if the user has indicated he/she still requires the reservation. If the result of this determination is negative, the reservation quest is satisfied at step 220. The control flow then exits at step 226. If the holder responds that he/she still requires the reservation, the reservation manager 124, at step 224, notifies the requesting user that the reservation request cannot be satisfied. The control then exits at step 226.

Computing System

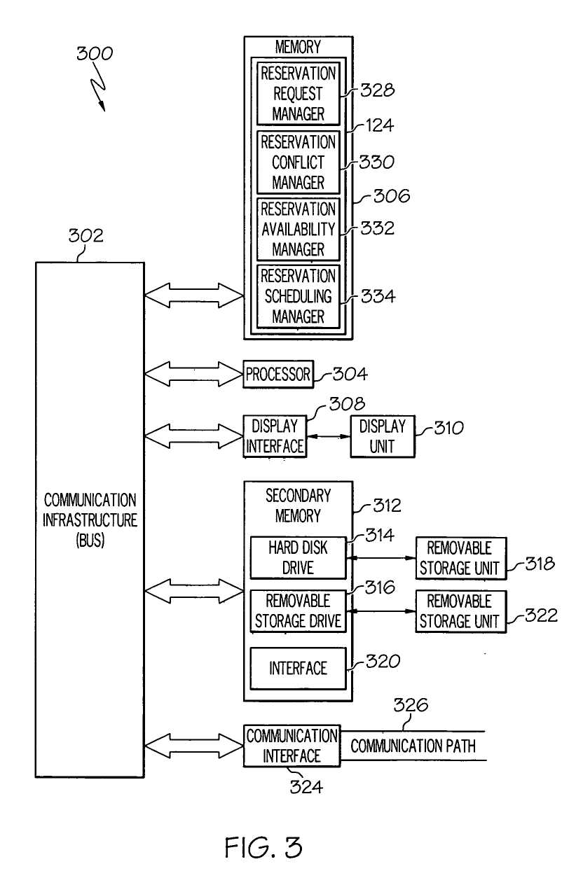

FIG. 3 is a high level block diagram illustrating a more detailed view of a computing system 300 useful for implementing the autonomic manager 112 according to embodiments of the present invention. The computing system 300 is based upon a suitably configured processing system adapted to implement an exemplary embodiment of the present invention. For example, a personal computer, workstation, or the like, may be used.

In one embodiment of the present invention, the computing system 300 includes one or more processors, such as processor 304. The processor 304 is connected to a communication infrastructure 302 (e.g., a communications bus, crossover bar, or network). Various software embodiments are described in terms of this exemplary computer system. After reading this description, it becomes apparent to a person of ordinary skill in the relevant art(s) how to implement the invention using other computer systems and/or computer architectures.

The computing system 300 can include a display interface 308 that forwards graphics, text, and other data from the communication infrastructure 302 (or from a frame buffer) for display on the display unit 310. The computing system 300 also includes a main memory 306, preferably random access memory (RAM), and may also include a secondary memory 312 as well as various caches and auxiliary memory as are normally found in computer systems. The main memory 306, in one embodiment, includes the reservation manager 124. The reservation manager 124 includes a reservation request manager 328 that is adapted to receive from a first user a request to reserve an item. The request includes a specification of at least one of a date and a time for a first reservation of the item. A reservation conflict manager 330 is adapted to determine that a second user holds a prior reservation for the item that conflicts with the first reservation. The reservation conflict manager is further adapted to determine that the second user no longer requires the prior reservation. A reservation availability manager 332 is adapted to release, in response to reservation conflict manager determining that the second user no longer requires the prior reservation, the prior reservation. A reservation scheduling manager 334 is adapted to allow, in response to the reservation availability manager releasing and in response to the reservation request manager receiving from the first user the request, the first reservation as specified by the request.

The secondary memory 312 may include, for example, a hard disk drive 314 and/or a removable storage drive 316, representing a floppy disk drive, a magnetic tape drive, an optical disk drive, and the like. The removable storage drive 316 reads from and/or writes to a removable storage unit 318 in a manner well known to those having ordinary skill in the art.

Removable storage unit 318, represents a floppy disk, a compact disc, magnetic tape, optical disk, etc. which is read by and written to by removable storage drive 316. As are appreciated, the removable storage unit 318 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer-readable information.

In alternative embodiments, the secondary memory 312 may include other similar means for allowing computer programs or other instructions to be loaded into the computing system 300. Such means may include, for example, a removable storage unit 322 and an interface 320. Examples of such may include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 322 to the computing system 300.

The computing system 200, in this example, includes a communications interface 324 that acts as an input and output and allows software and data to be transferred between the computing system 300 and external devices or access points via a communications path 326. Examples of communications interface 324 may include a modem, a network interface (such as an Ethernet card), a communications port, a PCMCIA slot and card, etc. Software and data transferred via communications interface 324 are in the form of signals which may be, for example, electronic, electromagnetic, optical, or other signals capable of being received by communications interface 324. The signals are provided to communications interface 324 via a communications path (i.e., channel) 326. The channel 326 carries signals and may be implemented using wire or cable, fiber optics, a phone line, a cellular phone link, an RF link, and/or other communications channels.

In this document, the terms “computer program medium,” “computer usable medium,” “computer readable medium”, “computer readable storage product”, and “computer program storage product” are used to generally refer to media such as main memory 306 and secondary memory 312, removable storage drive 316, and a hard disk installed in hard disk drive 314. The computer program products are means for providing software to the computer system. The computer readable medium allows the computer system to read data, instructions, messages or message packets, and other computer readable information from the computer readable medium.

Computer programs (also called computer control logic) are stored in main memory 306 and/or secondary memory 312. Computer programs may also be received via communications interface 324. Such computer programs, when executed, enable the computer system to perform the features of the various embodiments of the present invention as discussed herein. In particular, the computer programs, when executed, enable the processor 304 to perform the features of the computer system.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for managing reservations of items, the method comprising:
receiving from a first user a request to reserve an item, wherein the request comprises a specification of at least one of a date and a time for a first reservation of the item;
determining that a second user holds a prior reservation for the item that conflicts with the first reservation;
determining that the second user no longer requires the prior reservation;
releasing, in response to determining that the second user no longer requires the prior reservation, the prior reservation; and
allowing, in response to the releasing and in response to the receiving from the first user the request, the first reservation as specified by the request.

2. The method of claim 1, wherein the determining that the second user no longer requires the prior reservation comprises determining a change in status of the second user.

3. The method of claim 1, wherein the determining that the second user no longer requires the prior reservation is performed in response to receiving the request.

4. The method of claim 3, wherein the determining that the second user no longer requires the prior reservation further comprises querying the second user regarding a continued need for the prior reservation.

5. The method of claim 1, wherein the determining that the second user no longer requires the prior reservation further comprises:
analyzing organizational information to determine if the second user has been assigned a new organizational role since making the current reservation;
cancelling, in response to determining that the second user has been assigned a new organizational role, the prior reservation and allowing the reservation request; and
denying, in response to determining that the second user has not been assigned a new organizational role, the reservation request.

6. The method of claim 1, wherein determining that the second user no longer requires the prior reservation further comprises:
automatically generating a message requesting the second user to confirm the prior reservation;
transmitting the message that has been generated to the second user; and
determining that the second user no longer requires the prior reservation based upon at least one of a content of a response to the message and a failure to receive a response to the message.

7. The method of claim 6, wherein the failure to receive the response comprises:
determining that a given time period has expired since transmitting the message without receiving the response.

8. An information processing system for managing reservations of items, the information processing system comprising:
a memory;
a processor communicatively coupled to the memory; and
a reservation manager communicatively coupled to the memory and the processor, wherein the reservation manager includes:
a reservation request manager adapted to receive from a first user a request to reserve an item, wherein the request comprises a specification of at least one of a date and a time for a first reservation of the item;
a reservation conflict manager adapted to determine that a second user holds a prior reservation for the item that conflicts with the first reservation;
wherein the reservation conflict manager is further adapted to determine that the second user no longer requires the prior reservation;
a reservation availability manager adapted to release, in response to reservation conflict manager determining that the second user no longer requires the prior reservation, the prior reservation; and
a reservation scheduling manager adapted to allow, in response to the reservation availability manager releasing and in response to the reservation request manager receiving from the first user the request, the first reservation as specified by the request.

9. The information processing system of claim 8, wherein the reservation conflict manager is further adapted to determine that the second user no longer requires the prior reservation by determining a change in status of the second user.

10. The information processing system of claim 8, wherein the reservation conflict manager is further adapted to determine that the second user no longer requires the prior reservation in response to receiving the request.

11. The information processing system of claim 10, wherein the reservation conflict manager is further adapted to determine that the second user no longer requires the prior reservation by querying the second user regarding a continued need for the prior reservation.

12. The information processing system of claim 8, wherein the reservation conflict manager is further adapted to determine that the second user no longer requires the prior reservation by:
analyzing organizational information to determine if the second user has been assigned a new organizational role since making the current reservation;
canceling, in response to determining that the second user has been assigned a new organizational role, the prior reservation and allowing the reservation request; and
denying, in response to determining that the second user has not been assigned a new organizational role, the reservation request.

13. The information processing system of claim 8, wherein the reservation conflict manager is further adapted to determine that the second user no longer requires the prior reservation further comprises:
automatically generating a message requesting the second user to confirm the prior reservation;
transmitting the message that has been generated to the second user; and
determining that the second user no longer requires the prior reservation based upon at least one of a content of a response to the message and a failure to receive a response to the message.

14. The information processing system of claim 13, wherein the failure to receive the response comprises:
determining that a given time period has expired since transmitting the message without receiving the response.

15. A computer program product for managing reservations of items, the computer program product comprising:
a storage medium readable by the computer system, the computer readable medium storing instructions for performing:
receiving from a first user a request to reserve an item, wherein the request comprises a specification of at least one of a date and a time for a first reservation of the item;
determining that a second user holds a prior reservation for the item that conflicts with the first reservation;
determining that the second user no longer requires the prior reservation;
releasing, in response to determining that the second user no longer requires the prior reservation, the prior reservation; and
allowing, in response to the releasing and in response to the receiving from the first user the request, the first reservation as specified by the request.

16. The computer program product of claim 15, wherein the instructions for determining that the second user no longer requires the prior reservation comprises further instructions for determining a change in status of the second user.

17. The computer program product of claim 15, wherein the determining that the second user no longer requires the prior reservation is performed in response to receiving the request.

18. The computer program product of claim 15, wherein the instructions for determining that the second user no longer requires the prior reservation further comprise instructions for:
analyzing organizational information to determine if the second user has been assigned a new organizational role since making the current reservation;
canceling, in response to determining that the second user has been assigned a new organizational role, the prior reservation and allowing the reservation request; and
denying, in response to determining that the second user has not been assigned a new organizational role, the reservation request.

19. The computer program product of claim 15, wherein the instructions for determining that the second user no longer requires the prior reservation further comprise instructions for:
automatically generating a message requesting the second user to confirm the prior reservation;
transmitting the message that has been generated to the second user; and
determining that the second user no longer requires the prior reservation based upon at least one of a content of a response to the message and a failure to receive a response to the message.

20. The computer program product of claim 19, wherein the failure to receive the response comprises:
determining that a given time period has expired since transmitting the message without receiving the response.
